(19) United States
(12) Patent Application Publication
(10) Pub. No.: US 2024/0067156 A1
(43) Pub. Date: Feb. 29, 2024

(54) METHOD AND SYSTEM FOR CONTROLLING A MODULAR HYBRID TRANSMISSION

(71) Applicant: Ford Global Technologies, LLC, Dearborn, MI (US)

(72) Inventors: Timothy Baxendale, Portales, NM (US); Sassan Farahmand, Canton, MI (US); Fazal U. Syed, Canton, MI (US)

(21) Appl. No.: 17/821,712

(22) Filed: Aug. 23, 2022

(51) Int. Cl. B60W 20/15; B60W 10/08

(52) U.S. Cl. CPC B60W 20/15; B60W 10/08; B60W 2050/0011

(57) ABSTRACT

Methods and systems are provided for increasing an efficiency of a modular hybrid transmission (MHT) of a hybrid vehicle. In one example, a method for operating an MHT comprises, at one or more control modules, determining an upper torque bound and a lower torque bound of a feedback controller based on a feedforward (FF) engine torque value, the feedback controller controlling a torque of an electric motor of the hybrid vehicle; and constraining operation of the electric motor via the feedback controller based on the upper and lower torque bounds. The electric motor may be controlled by a hybrid powertrain control module of the MHT. The upper and lower torque bounds may be calculated at a powertrain control module of the MHT based on torque converter losses.

### FIELD

The present description relates to controlling a speed of an electric motor of a modular hybrid transmission of a hybrid vehicle.

### BACKGROUND AND SUMMARY

A hybrid vehicle may include a powertrain where torque may be delivered to wheels of the hybrid vehicle by either an internal combustion engine (engine) and/or an electric motor (e-motor). The powertrain may be configured as a modular hybrid transmission (MHT), where the engine is coupled to the e-motor via a disconnect clutch. The e-motor and the engine may be operated so as to reach a target speed (e.g., speed control) or so as to reach a target torque (e.g., torque control). A speed and/or torque of the e-motor and a speed and/or torque of the engine may be set by different controllers. In one example, the e-motor may be controlled by a hybrid powertrain control module (HPCM) while a powertrain control module (PCM) may be configured to control the powertrain system including sending commands to the HPCM.

When the e-motor is operated in speed control mode and the engine is operated in torque control mode, the PCM may contribute to setting a torque of the e-motor by sending a feedforward (FF) torque command to the HPCM. When the e-motor is coupled to the engine, a speed of the engine and speed of the e-motor may be substantially the same. As a result, the FF torque value from the PCM may be a sign flipped engine torque.

However, the inventors herein have recognized a problem with controlling the speed of the e-motor using the FF torque value. When the e-motor is decoupled from the engine, the FF torque value sent to the HPCM may be a combination of drag from the engine (e.g., disconnect clutch drag) and converter losses. The HPCM may include a feedback controller (e.g., proportional integral derivative (PID) controller) which may adjust the torque of the e-motor by adding or subtracting an amount from the FF torque value to better match the speeds of the engine and e-motor. For example, the PID controller may calculate a desired torque to add to the FF torque value based on a speed error. The amount added or subtracted may include a correction for converter losses. As a result, a situation may occur where the converter losses may be compensated for both by the PID controller of the HPCM and in the FF torque value received from the PCM, resulting in an undesirable increase in speed delivered by the e-motor to an impeller of a torque converter coupled to the e-motor.

In one example, the above issue may be at least partly addressed by a method for controlling a hybrid vehicle, comprising, at one or more control modules, determining an upper torque bound and a lower torque bound of a feedback controller based on a feedforward (FF) engine torque value, the feedback controller controlling a torque of an electric motor of the hybrid vehicle; and constraining operation of the electric motor via the feedback controller based on the upper and lower torque bounds. In this way, an electric motor torque may be maintained within the range imposed by the standards without relying on an integral term in the feedback controller to account for converter losses, and the undesirable increase in speed may not be generated.

In some embodiments, the PCM may calculate converter losses and send them to the HPCM, which may calculate the upper and lower bounds of the torque value range. In other embodiments, the upper and lower bounds of the torque value range may be calculated by the PCM and sent to the HPCM along with the FF engine torque value, and the HPCM runs the PID controller within the provided bounds. Further, the upper and lower torque bounds sent to the HPCM may be offsets of the FF engine torque value, which may allow for a wider range of value coverage without expanding a size of a data set needed to represent the range.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 shows an example embodiment of a vehicle driveline in an MHT configuration;

FIG. 2A is a flowchart illustrating a first exemplary method for controlling a torque of an e-motor of a hybrid vehicle, in accordance with one or more embodiments of the present disclosure;

FIG. 2B is a flowchart illustrating a second exemplary method for controlling a torque of an e-motor of a hybrid vehicle, in accordance with one or more embodiments of the present disclosure;

FIG. 3A is a flowchart illustrating a third exemplary method for controlling a torque of an e-motor of a hybrid vehicle, in accordance with one or more embodiments of the present disclosure;

FIG. 3B is a flowchart illustrating a fourth exemplary method for controlling a torque of an e-motor of a hybrid vehicle, in accordance with one or more embodiments of the present disclosure;

FIG. 4A is a first exemplary control diagram showing an operation of an electric motor of a hybrid vehicle in a speed-control mode, in accordance with one or more embodiments of the present disclosure;

FIG. 4B is a second exemplary control diagram showing an operation of an electric motor of a hybrid vehicle in a speed-control mode, in accordance with one or more embodiments of the present disclosure; and

FIG. 5 is an exemplary timing diagram illustrating a first sequence of events during a disconnection of an engine from an MHT of a hybrid vehicle, in accordance with one or more embodiments of the present disclosure.

### DETAILED DESCRIPTION

The present description is related to controlling a speed of an e-motor of a hybrid electric vehicle. Hybrid electric vehicles may include a powertrain in a modular hybrid transmission (MHT) configuration, where an internal combustion engine is coupled with an e-motor in series to provide the power needed to propel a vehicle for improved fuel economy over a conventional vehicle. One way to improve the fuel economy of a hybrid vehicle is to shut down the engine during times that the engine operates inefficiently, and to use the e-motor to provide the power to propel the vehicle. A disconnect clutch positioned between the e-motor and the engine may be selectively engaged or disengaged to couple or decouple the engine from the e-motor. The disconnect clutch may be controlled by a controller of the MHT, which may include various control modules, such as a powertrain control module (PCM) and a hybrid powertrain control module (HPCM).

When the engine is disengaged, the e-motor may be commanded to generate a torque equivalent to an engine torque supplied at the time of disengagement. In various embodiments, when the disconnect clutch is disengaged (e.g., uncoupling engine torque output from the hybrid powertrain), the PCM may transmit a target engine torque to the HPCM, which may control the e-motor torque based on the target engine torque via a feedback controller. The target engine torque may account for loss generated at a torque converter of the MHT due to slippage. However, the feedback controller may also have learned to account for the torque converter loss. As a result, when the target engine torque is inputted into feedback controller, the torque converter loss may be overcompensated for, generating a spike in e-motor speed that may exceed a threshold established by operational standards. Methods are proposed herein to address this overcompensation (e.g., double compensation).

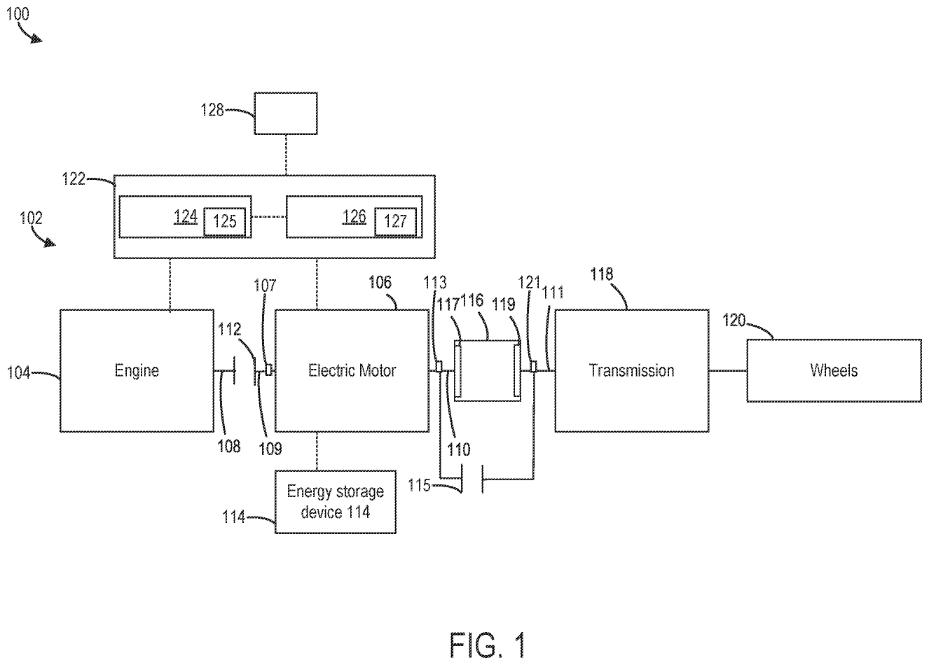

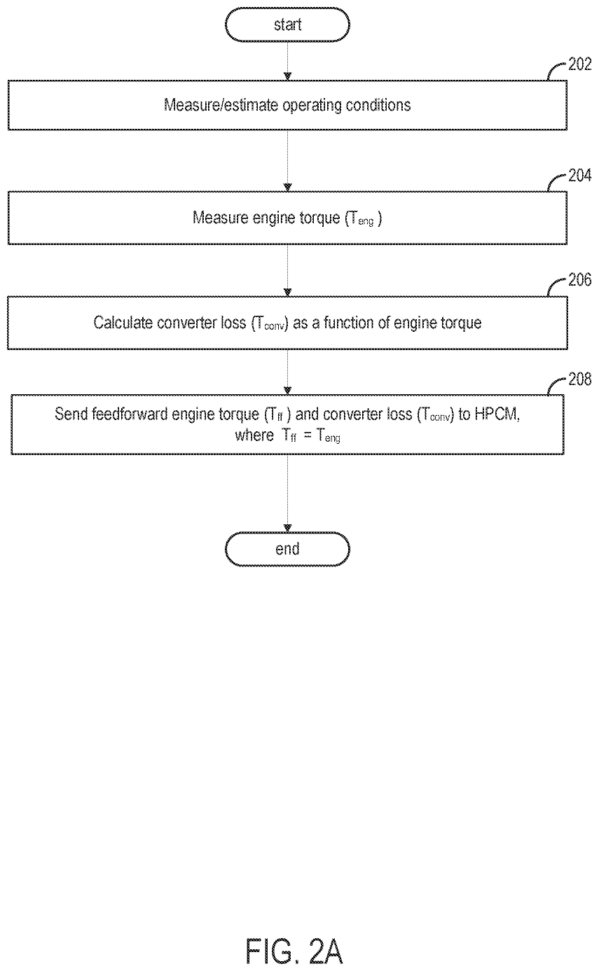

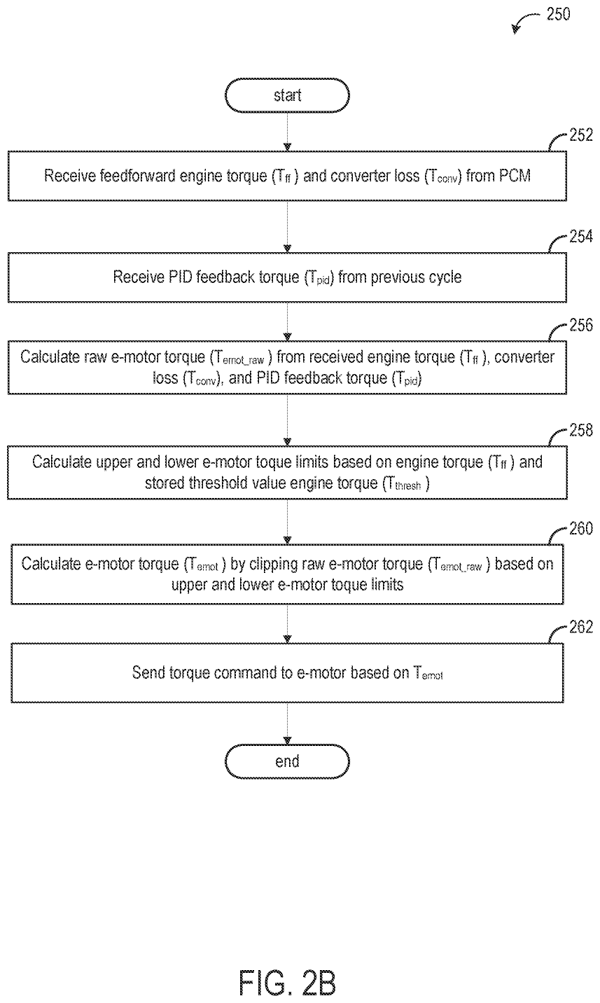

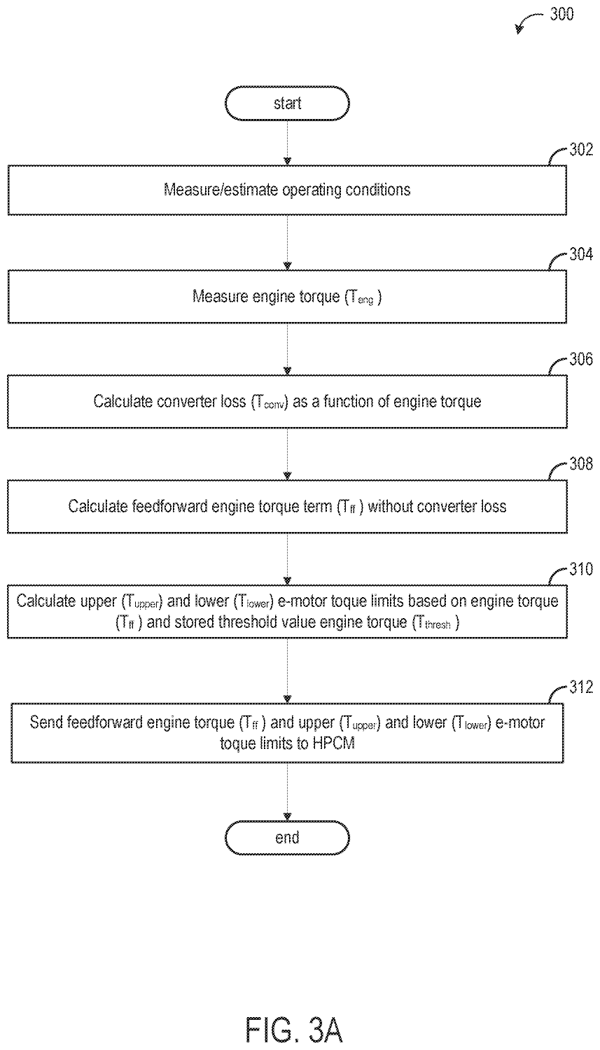

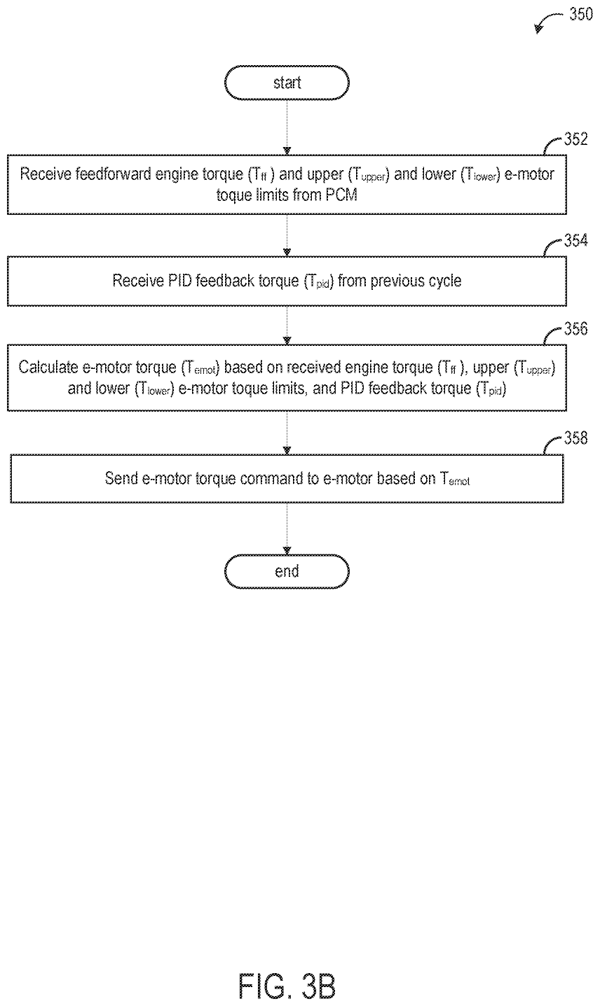

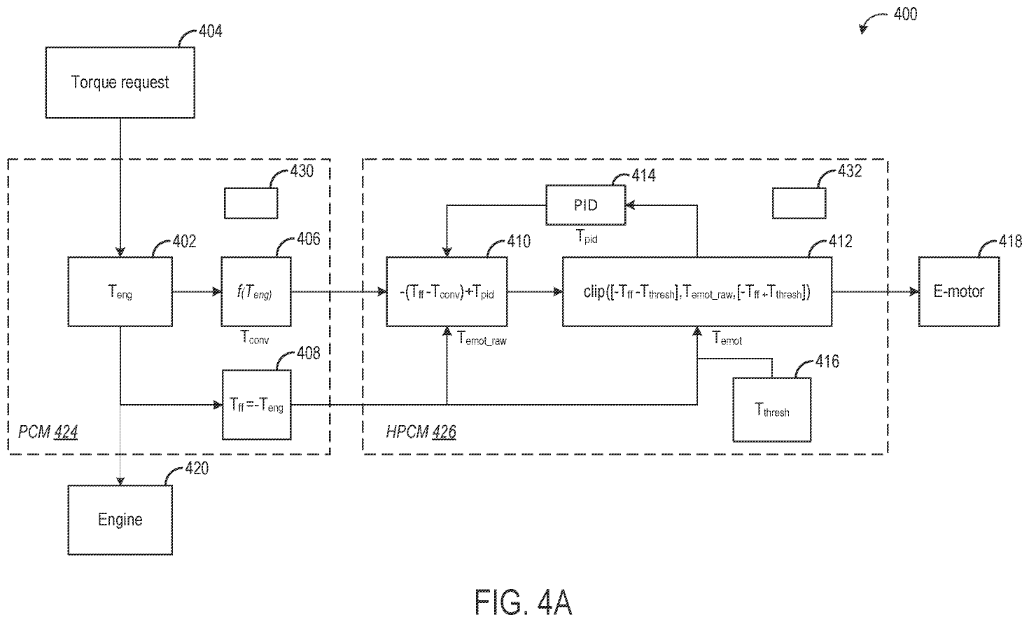

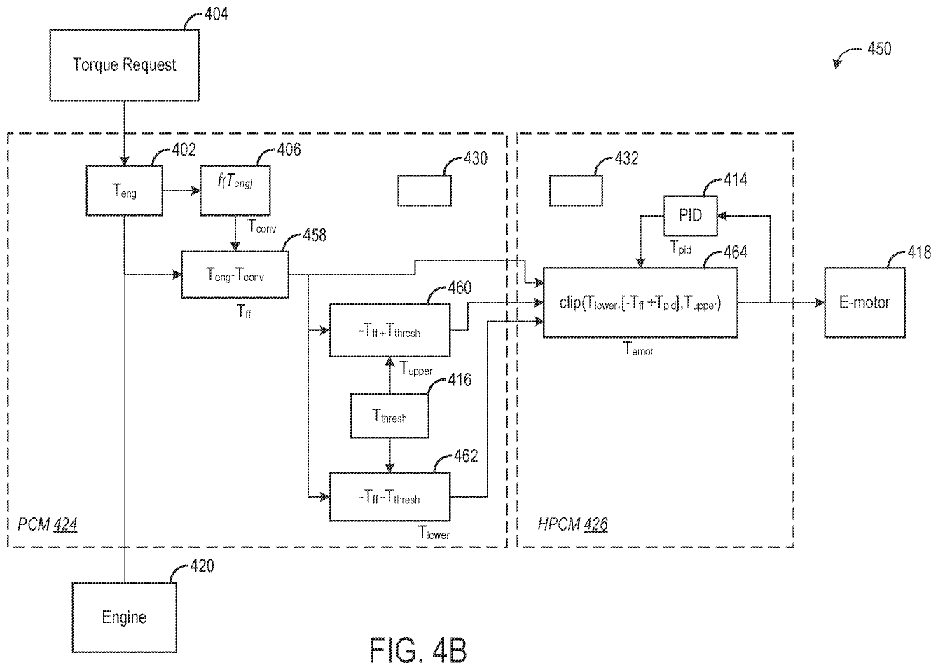

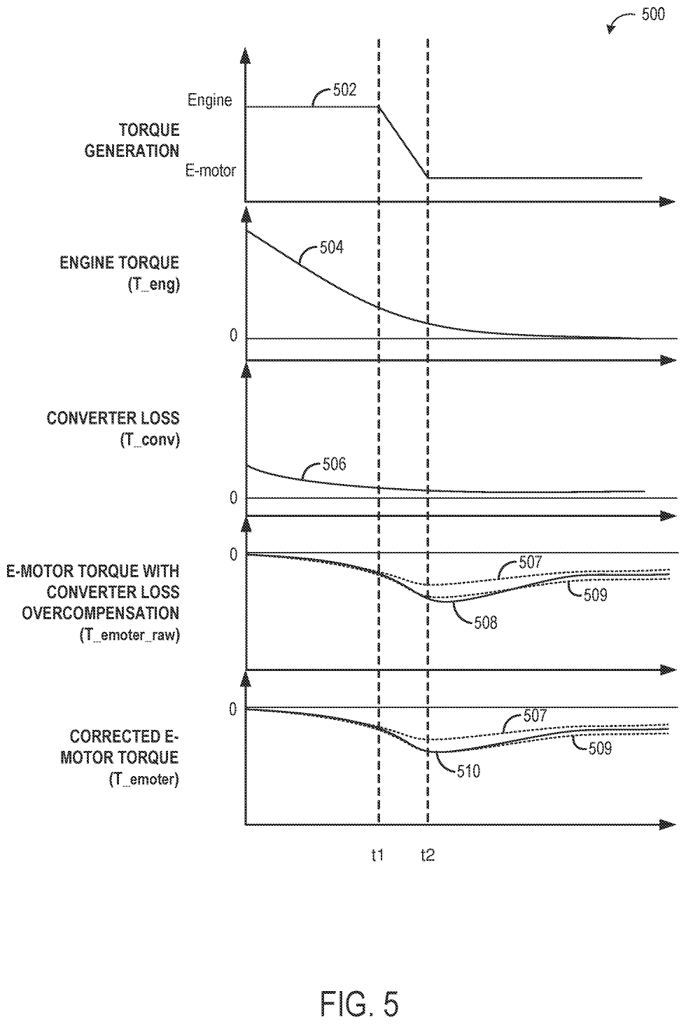

An exemplary MHT including an engine and an e-motor is shown in FIG. 1. A first set of methods for addressing the overcompensation of torque converter losses when controlling the e-motor is described in reference to FIGS. 2A and 2B, where FIG. 2A illustrates a method carried out by a PCM of the MHT, and FIG. 2B illustrates a corresponding method carried out by an HPCM of the MHT. A second set of methods for addressing the overcompensation of the torque converter losses is described in reference to FIGS. 3A and 3B, where FIG. 3A illustrates a method carried out by the PCM, and FIG. 3B illustrates a corresponding method carried out by the HPCM. FIG. 4A shows a control diagram illustrating a flow of data from the PCM to the HPCM in accordance with the first set of methods. FIG. 4B shows a control diagram illustrating a flow of data from the PCM to the HPCM in accordance with the second set of methods. FIG. 5 shows a timing of various events during a decoupling of the engine from the e-motor when the first or second sets of methods are carried out.

Referring to FIG. 1, a diagram of a hybrid vehicle 100 is shown including a powertrain 102. Powertrain 102 may be configured as a modular hybrid transmission (MHT) including an engine 104 coupled to an electric motor (e-motor) 106 via a disconnect clutch 112. In one example, engine 104 may be an internal combustion engine configured to combust fuel such as gasoline, diesel, and/or natural gas among others.

An engine shaft 108 of engine 104 may couple engine 104 to disconnect clutch 112. In some embodiments, a dual mass flywheel may be included in powertrain 102 between engine 104 and disconnect clutch 112 (not shown in FIG. 1). Electric motor 106 may be configured as motor/generator including an input shaft 109 and output shaft 110. Input shaft 109 may couple to disconnect clutch 112. In one example, disconnect clutch 112 may be fully locked (e.g., engaged) when speeds of engine 104 and e-motor 106 are substantially the same. A torque sensor 107 may measure a torque generated on input shaft 109 by engine 104.

E-motor 106 may be operated to provide torque to powertrain 102 or to convert driveline torque into electrical energy to be stored in an electric energy storage device 114. Electrical energy storage device 114 may be a battery, capacitor, or inductor. When e-motor 106 may be operated as a generator (e.g., during regenerative braking), e-motor 106 may provide electrical power to charge electrical energy storage device 114. In some examples, vehicle 100 may be a plug-in hybrid vehicle and electrical energy storage device 114 may be charged by coupling to an external power source.

Output shaft 110 may be coupled to a torque converter 116 which may be coupled to an input shaft 111 of an automatic transmission 118. Torque converter 116 includes an impeller 117 to receive torque from e-motor 106 and a turbine 119 to output torque to transmission 118. Torque converter 116 also includes a torque converter bypass (e.g., lock-up) clutch 115. Torque is directly transferred from impeller 117 to turbine 119 when bypass clutch 115 is locked. Alternatively, bypass clutch 115 may be hydraulically locked. Torque converter impeller speed and position may be determined via a sensor 113. Torque converter turbine speed and position may be determined via a sensor 121. In some examples, sensors 113 and/or 121 may be torque sensors or may be combination position and torque sensors.

When bypass clutch 115 is fully disengaged, torque converter 116 transmits engine torque to automatic transmission 118 via fluid transfer between impeller 117 and turbine 119, thereby enabling torque multiplication. In contrast, when bypass clutch 115 is fully engaged, torque is directly transferred via bypass clutch 115 to transmission input shaft 111. Alternatively, the bypass clutch 115 may be partially engaged, thereby enabling the amount of torque directly relayed to transmission 118 to be adjusted. An output side of transmission 118 may be coupled to wheels 120 of hybrid vehicle 100.

Engine 104 and electric motor 106 may be communicatively coupled to a controller 122. Controller 122 may receive inputs from one or more user controls 128. In one example, user controls 128 may include a gas pedal and/or a brake pedal. Controller 122 may be configured to receive inputs from engine 104, and accordingly control a torque output of engine 104 and/or e-motor 106, operation of torque converter 116, transmission 118, and/or other components of powertrain 102. As one example, an engine torque output may be controlled by adjusting a combination of spark timing, fuel pulse width, fuel pulse timing, and/or air charge, by controlling throttle opening and/or valve timing, valve lift and boost for turbo- or super-charged engines. In the case of a diesel engine, controller 122 may control the engine torque output by controlling a combination of fuel pulse width, fuel pulse timing, and air charge. In all cases, engine control may be performed on a cylinder-by-cylinder basis to control the engine torque output. Controller 12 may also control torque output and electrical energy production from e-motor 106 by adjusting current flowing to and from windings of e-motor 106 as is known in the art. Controller 122 may be configured to adjust the amount of torque transmitted by torque converter 116 by adjusting bypass clutch 115 in response to various engine operating conditions, or based on a driver-based engine operation request.

Controller 122 may include one or more sub-controllers configured to control separate components of vehicle 100. In one example, controller 122 may include a powertrain control module (PCM) 124 configured to control components of powertrain 102 such as engine 104, electric motor 106, and disconnect clutch 112, etc. Additionally, controller 122 may include a hybrid powertrain control module (HPCM) 126 configured to control electric motor 106. HPCM 126 may be communicatively coupled to PCM 124 and may relay instructions from PCM 124 to electric motor 106. For example, PCM 124 may send an engine torque value to HPCM 126, which may calculate an allowed torque for the e-motor based on the received engine torque value.

PCM 124 may include a PID controller 125, which may control an operation of engine 104. For example, PID controller 125 may operate engine 104 in a torque control mode to meet or maintain a torque target, or in a speed control mode to meet or maintain a speed target. Similarly, HPCM 126 may include a PID controller 127, which may be used to control e-motor 106 in a torque control mode or a speed control mode.

When PCM 124 controls engine 104 in a torque control mode, and HPCM controls e-motor 106 in a speed control mode, PCM 124 may send a feedforward (FF) value to HPCM 126 which may be equal (in magnitude) to a value of the engine torque, although with an opposite sign (e.g., sign flipped or negative vs. positive). The FF value may be used by PID controller 127 to control e-motor 106 in the speed control mode. HPCM 126 (and PID controller 127) may control the speed of e-motor 106 such that the torque of e-motor 106 is maintained within a threshold of an allowed torque corresponding to the (sign-flipped) FF value, to perform within operational standards. HPCM 126 may adjust the torque of e-motor 106 to compensate for power losses. For example, losses may be generated due to slippage at torque converter 116 during a hydraulic transfer of power from impeller 117 to turbine 119.

In addition to engine torque, the FF value supplied to PID controller 127 may include drag from disconnect clutch 112 and the loss generated at torque converter 116. When engine 104 is decoupled from powertrain 102, the drag and converter losses may be sent to PID controller 127 via the FF term (e.g., which no longer includes engine torque). However, PID controller 127 may have already learned an integral term that adjusts e-motor torque to compensate for converter losses. As a result, a temporary increase in the speed of impeller 117 may be generated as a result of a double compensation for the converter losses. A proposed method for eliminating this double compensation is described below in FIGS. 2A and 2B.

FIGS. 2A and 2B show a first set of exemplary methods for controlling a torque of an e-motor of a hybrid vehicle to account for converter losses when transferring power from an engine of the hybrid vehicle to the e-motor when the engine is decoupled from a powertrain of the hybrid vehicle. The powertrain may be configured as an MHT, where the engine and e-motor may be non-limiting embodiments of engine 104 and e-motor 106 of powertrain 102 of FIG. 1. In FIG. 2A, a first method 200 is shown for controlling the torque of the e-motor from a perspective of a PCM of the powertrain, such as PCM 124 of powertrain 102. Method 200 may be carried out by a processor of the PCM.

Method 200 begins at 202, where vehicle and engine operating conditions may be estimated and/or measured. These may include, for example, engine speed, battery state of charge, MAP, BP, engine temperature, ambient conditions including ambient temperature, pressure, and humidity, boost level, EGR rate and amount, etc.

At 204, method 200 includes measuring an torque T_{eng} of the engine. In various embodiments, the engine torque may be measured by a torque sensor of the engine (e.g., torque sensor 107).

At 206, method 200 includes calculating a converter loss T_{conv}, representing an amount of torque loss at a torque converter of the powertrain (e.g., torque converter 116). As a result of a hydraulic coupling between an impeller and a turbine of the torque converter, an amount of power outputted by the engine and/or the e-motor may be lost due to internal slippage. The loss of power (e.g., torque) may be a function of a total amount of power generated by the engine. For example, the converter loss T_{conv} may be 5% of the measured engine torque T_{eng}. In some embodiments, T_{conv} may be calculated based on a known function. In other embodiments, T on, may be retrieved from a lookup table in a memory of the PCM based on the engine torque T_{eng}.

At 208, method 200 includes sending a FF engine torque value T_{ff} and the converter loss value T on, to an HPCM of the hybrid vehicle. At a time of decoupling the engine from the powertrain, a speed of the engine and speed of the e-motor may be substantially the same. As a result, the FF engine torque value T_{ff} may be equal to a sign flipped engine torque T_{eng}. As described below in reference to FIG. 2B, the values T_{ff} and T_{conv} may become terms in calculations performed by a PID controller of the HPCM to control a speed of the e-motor based on torque limits imposed by vehicle standards. Method 200 ends.

FIG. 2B shows a second exemplary method 250 for controlling the torque of an e-motor of a hybrid vehicle to account for converter losses, based on a FF engine torque value T_{ff} supplied by a PCM of the hybrid vehicle as described above in method 200, from a perspective of an HPCM of an MHT of a hybrid vehicle (e.g., HPCM 126 of powertrain 102). The e-motor torque may be controlled in a speed control mode during a decoupling of an engine of the hybrid vehicle from the e-motor when engine torque is no longer desired. Method 250 may be carried out by a processor of the HPCM.

Method 250 begins at 252, where method 250 includes receiving the FF engine torque value T_{ff} and a converter loss term T_{conv} from the PCM, as described above. At 254, method 250 includes receiving a PID feedback torque T_{pid} from a PID controller (e.g., PID controller 127) from a previous cycle of the PID controller during operation in the speed control mode.

At 256, method 250 includes calculating a raw e-motor torque T_{emot_raw} from the received FF engine torque value T_{ff} and converter loss term T_{conv}, and the PID feedback torque T_{pid}. In various embodiments, the raw e-motor torque may be calculated according to equation 1 below:

T_{emot_raw}=−(T_{ff}−T_{conv})+T_{pid} (1)

At 258, method 250 includes calculating an upper e-motor torque bound Tᵤₚₚₑᵣ and a lower e-motor torque bound T_{lower}. T_{lower} may be a threshold value bounding how much lower T_{emot_raw} is allowed to be than −T_{ff}(e.g., in accordance with operational standards). Tᵤₚₚₑᵣ may be a threshold value bounding how much higher T_{emot_raw} is allowed to be than −T_{ff}. Tᵤₚₚₑᵣ and T_{lower} may be based on a pre-defined torque threshold Tₜₕᵣₑₛₕ, in accordance with equations 2 and 3 below:

Tᵤₚₚₑᵣ=−T_{eng}+Tₜₕᵣₑₛₕ (2)

T_{lower}=−T_{eng}−Tₜₕᵣₑₛₕ (3)

In various embodiments, Tₜₕᵣₑₛₕ may be established by an original equipment manufacturer (OEM) of the MHT and stored in a memory of the HPCM. In equations 2 and 3, a single torque threshold Tₜₕᵣₑₛₕ is used to generate both Tᵤₚₚₑᵣ and T_{lower}, where Tᵤₚₚₑᵣ and T_{lower} may be equal in magnitude. In other examples, a first torque threshold T_{thresh_upper} may be used to generate Tᵤₚₚₑᵣ, and a second toque threshold T_{thresh_lower} may be used to generate T_{lower}, where Tᵤₚₚₑᵣ and T_{lower} may be of different magnitudes.

Additionally, in some embodiments, Tᵤₚₚₑᵣ and T_{lower} may be offsets of T_{ff}, which may allow for a wider range of value coverage without expanding the size of the data set used to represent the range. For example, if T_{ff} is limited to 3×11 bit signals with 2048 unique values, then T_{ff} may not be properly constrained by Tₜₕᵣₑₛₕ as T_{ff} approaches Tᵤₚₚₑᵣ and T_{lower}. In contrast, if Tᵤₚₚₑᵣ and T_{lower} are sent as torque around T_{eng}, a functional range between Tᵤₚₚₑᵣ and T_{lower} may be increased (e.g., an upper limit of T_{eng} plus 2048, and lower limit of T_{eng} minus 2048). However, since sometimes T_{ff} will have a converter compensation, the lower offset may be adjusted to cover T_{eng}−T_{lower} but relative to T_{ff} instead.

For example, T_{ff} may be allowed to range from −500 to 1547 in increments of 1 Nm (e.g., 2048 total values), and the upper limit may be allowed to range from 0 to 2047 Nm in increments of 1 Nm (e.g., so an absolute upper limit could be as high as 1547+2047). The lower limit may be allowed to be −1000 to 1047 Nm, in increments of 1 Nm (e.g., not −2047 to 0, because drag losses (converter, friction) are generally assumed, which may result in T_{ff} being much lower than T_{eng}. If limits are +−1000, then global limit values are −500 to 1500. T_{ff} would be 0, since T_{eng}−T_{conv}=0. In this case, the positive relative adjustment would be 1500 Nm and the negative adjustment limit would be −500.

At 260, method 250 includes calculating an e-motor torque Tₑₘₒₜ by clipping T_{emot_raw} based on Tᵤₚₚₑᵣ and T_{lower}, as described in equation 4 below:

Tₑₘₒₜ=Clip([−T_{ff}−Tₜₕᵣₑₛₕ],T_{emot_raw},[−T_{ff}+Tₜₕᵣₑₛₕ]) (4)

In accordance with equation 4, Tₑₘₒₜ may be set to Tᵤₚₚₑᵣ if Tₑₘₒₜ exceeds the upper torque bound, and Tₑₘₒₜ may be set to T_{lower} if Tₑₘₒₜ exceeds the lower torque bound. In this way, Tₑₘₒₜ may be maintained within the allowed torque bounds. By subtracting the converter loss term T_{conv} from T_{ff} to generate T_{emot_raw}, and maintaining Tₑₘₒₜ within the calculated torque bounds, a spike in e-motor speed resulting from accounting for converter losses twice may be averted. By averting the spike in e-motor speed, an efficiency and a performance of the MHT is increased, resulting in a more desirable driver experience.

At 262, method 250 includes sending a torque command to the e-motor based on Tₑₘₒₜ, and method 250 ends.

FIGS. 3A and 3B show a second set of exemplary methods for controlling a torque of an e-motor of a hybrid vehicle to account for converter losses when transferring power from an engine of the hybrid vehicle to the e-motor when the engine is decoupled from a powertrain of the hybrid vehicle. The engine and e-motor may be non-limiting embodiments of engine 104 and e-motor 106 of powertrain 102 of FIG. 1. In FIG. 3A, a first method 300 is shown for controlling the torque of the e-motor from a perspective of a PCM of the powertrain, such as PCM 124 of powertrain 102. Method 200 may be carried out by a processor of the PCM.

Steps 302, 304, and 306 of method 300 may be substantially similar to steps 202, 204, and 206 of method 200 described above, where after measuring/estimating vehicle and engine operating conditions, an torque T_{eng} of the engine is measured and a converter loss T_{conv} is calculated, for example, as a function of T_{eng}.

At 308, method 300 includes calculating a FF engine torque value T_{ff} to send to an HPCM of the hybrid vehicle, where a torque converter loss is subtracted from T_{eng} as described by equation 5 below:

T_{ff}=T_{eng}−T_{conv} (5)

In contrast with methods 200 and 250, the converter loss term T_{conv} is not sent to the HPCM separately from T_{ff}, and T_{ff} includes a compensation for the converter loss.

At 310, method 300 includes calculating the upper e-motor torque bound Tᵤₚₚₑᵣ and the lower e-motor torque bound T_{lower}, where T_{lower} may be a threshold value bounding how much lower T_{emot_raw} is allowed to be than −T_{ff}, and Tᵤₚₚₑᵣ may be a threshold value bounding how much higher T_{emot_raw} is allowed to be than −T_{ff}. As described above in reference to FIGS. 2A and 2B, Tᵤₚₚₑᵣ and T_{lower} may be based on a pre-defined torque threshold Tₜₕᵣₑₛₕ, in accordance with equations 2 and 3 above. As mentioned above, in some embodiments, Tᵤₚₚₑᵣ and T_{lower} may be offsets of T_{ff}.

At 312, method 300 includes sending the FF engine torque value T_{ff} and the torque bounds Tᵤₚₚₑᵣ and T_{lower} to an HPCM of the hybrid vehicle, and method 300 ends.

FIG. 3B shows a second exemplary method 350 for controlling the torque of an e-motor of a hybrid vehicle to account for converter losses, based on a FF engine torque value T_{ff} and torque bounds Tᵤₚₚₑᵣ and T_{lower} supplied by a PCM of the hybrid vehicle as described above in method 300, from a perspective of an HPCM of an MHT of a hybrid vehicle (e.g., HPCM 126 of powertrain 102). The e-motor torque may be controlled in a speed control mode during a decoupling of an engine of the hybrid vehicle from the e-motor when engine torque is no longer desired. Method 350 may be carried out by a processor of the HPCM.

Method 350 begins at 352, where method 350 includes receiving the FF engine torque value T_{ff} and the torque bounds Tᵤₚₚₑᵣ and T_{lower} from the PCM. At 354, method 350 includes receiving a PID feedback torque T_{pid} from a PID controller (e.g., PID controller 127) from a previous cycle of the PID controller during operation in the speed control mode.

At 356, method 350 includes calculating an e-motor torque Tₑₘₒₜ from the received FF engine torque value T_{ff}, the torque bounds Tᵤₚₚₑᵣ and T_{lower}, and the PID feedback torque T_{pid}. In various embodiments, the e-motor torque Tₑₘₒₜ may be calculated according to equation 1 below:

Tₑₘₒₜ=clip(T_{lower},[−T_{ff}+T_{pid}],Tᵤₚₚₑᵣ) (6)

where a raw e-motor torque is first calculated based on T_{ff} and T_{pid}, and the raw e-motor torque is clipped to constrain Tₑₘₒₜ within Tᵤₚₚₑᵣ and T_{lower}. As described above in reference to FIG. 2B, in accordance with equation 6, Tₑₘₒₜ may be set to Tᵤₚₚₑᵣ if Tₑₘₒₜ exceeds the upper torque bound, and Tₑₘₒₜ may be set to T_{lower} if Tₑₘₒₜ exceeds the lower torque bound.

At 358, method 350 includes sending a torque command to the e-motor based on Tₑₘₒₜ, and method 350 ends.

FIG. 4A shows a first exemplary control system 400 of an MHT of a hybrid vehicle. Control system 400 operates within a controller of the MHT, where the controller includes a PCM 424 and an HPCM 426. The controller, PCM 424, and HPCM 426 may be non-limiting examples of controller 122, PCM 124, and HPCM 126 of FIG. 1. Control system 400 controls a speed of an e-motor 418 of the MHT in a speed-control mode. In particular, FIG. 4A shows a flow of signals through control system 400 as an engine 420 of the MHT is decoupled from e-motor 418, where the signals are calculated at various blocks of control system 400. Control system 400 may take as input a torque request 404, and may output an e-motor torque to e-motor 418 to control the speed of the e-motor based on torque request 404.

Torque request 404 may be a driver demand for torque received from one or more user controls (e.g., user controls 128), such as an accelerator, or torque request 404 may be received from the controller based on instructions executed in a processor of the controller in response to a driving condition. For example, in response to the vehicle achieving a target velocity and a driver demand for torque decreasing below a threshold, the controller may command engine 420 to be decoupled from e-motor 418 and that torque be supplied by e-motor 418. HPCM 426 may then be commanded to operate in the speed control mode to maintain the vehicle at the target velocity. Maintaining the vehicle at the target velocity includes calculating, at HPCM 426, an amount of torque to generate at e-motor 418. Control system 400 depicts a flow of signals generated when the speed of e-motor 418 is controlled via methods 200 and 250 described above.

PCM 424 includes a tangible and non-transitory computer readable medium (memory) 430 in which programming instructions for controlling engine 420 are stored. Engine 420 may be controlled in a speed control mode, or a torque control mode. HPCM 426 includes a tangible and non-transitory computer readable medium (memory) 432 in which programming instructions for controlling e-motor 418 are stored. E-motor 418 may be controlled in a speed control mode or a torque control mode.

As used herein, the term tangible computer readable medium is expressly defined to include various types of computer readable storage and to exclude merely propagating signals. Additionally or alternatively, the example methods and systems may be implemented using coded instruction (e.g., computer readable instructions) stored on a non-transitory computer readable medium such as a flash memory, a read-only memory (ROM), a random-access memory (RAM), a cache, or any other storage media in which information is stored for any duration (e.g. for extended period time periods, permanently, brief instances, for temporarily buffering, and/or for caching of the information).

Memory and processors as referred to herein can be standalone or integrally constructed as part of various programmable devices (e.g., computers). Computer memory of computer readable storage mediums as referenced herein may include volatile and non-volatile or removable and non-removable media for a storage of electronic-formatted information such as computer readable program instructions or modules of computer readable program instructions, data, etc. that may be stand-alone or as part of a computing device. Examples of computer memory may include, but are not limited to RAM, ROM, EEPROM, flash memory, or any other medium which can be used to store the desired electronic format of information and which can be accessed by the processor or processors or at least a portion of a computing device.

Torque request 404 is an input into an engine torque measurement block 402, where an engine torque T_{eng} is measured (e.g., via a torque sensor such as torque sensor 107). The engine torque T_{eng} outputted by engine torque measurement block 402 is an input into engine 420 when engine 420 is used to propel wheels of the vehicle. The engine torque T_{eng} outputted by engine torque measurement block 402 is also an input into a torque converter loss calculation block 406, where a loss in torque due to fluid mechanics inside the torque converter is calculated. The converter loss T_{conv} may be calculated as a function of T_{eng}. In various embodiments, the converter loss T_{conv}, may be retrieved from a lookup table stored in memory 430 based on T_{eng}.

Torque request 404 is an input into a feedforward (FF) engine torque calculation block 408, where a FF engine torque value T_{ff} is calculated based on T_{eng}. At a time of decoupling engine 420 from e-motor 418, a torque commanded to be supplied by the e-motor is the same as the engine torque (with a sign flipped), where T_{ff} is equal to −T_{eng}.

As described above in reference to methods 200 and 250, the T_{ff} value outputted by FF engine torque calculation block 408 and the converter loss T_{conv} outputted by torque converter loss calculation block 406 are sent from PCM 424 to HPCM 426 to be inputs into an e-motor torque calculation block 410 of HPCM 426. At e-motor torque calculation block 410, an e-motor torque is calculated based on T_{ff}, T_{conv}, and a PID controller feedback torque term T_{pid}, in accordance with equation 1 above. A raw e-motor torque T_{emot_raw} outputted by e-motor torque calculation block 410 is an input into an e-motor torque constraint block 412 of HPCM 426. Other inputs into e-motor torque constraint block 412 include the T_{ff} outputted by engine torque calculation block 408 of PCM 424, and a torque threshold Tₜₕᵣₑₛₕ outputted by a torque threshold calculation block 416. In various embodiments, Tₜₕᵣₑₛₕ is stored in memory 432 of HPCM 426.

At e-motor torque constraint block 412, T_{emot_raw} is constrained to be within the torque threshold Tₜₕᵣₑₛₕ of T_{ff}. If T_{emot_raw} exceeds an upper bound (−T_{ff}+Tₜₕᵣₑₛₕ), e-motor torque constraint block 412 outputs an e-motor torque Tₑₘₒₜ equivalent to −T_{ff}+Tₜₕᵣₑₛₕ. If T_{emot_raw} exceeds a lower bound (−T_{ff}−Tₜₕᵣₑₛₕ), e-motor torque constraint block 412 outputs an e-motor torque Tₑₘₒₜ equivalent to −T_{ff}−Tₜₕᵣₑₛₕ. If T_{emot_raw} does not exceed either the upper bound or the lower bound, e-motor torque constraint block 412 outputs an e-motor torque Tₑₘₒₜ equivalent to T_{emot_raw}.

The Tₑₘₒₜ value outputted by e-motor torque constraint block 412 is an input into e-motor 418 to propel the vehicle. The Tₑₘₒₜ value outputted by e-motor torque constraint block 412 is also an input into a PID controller 414 of HPCM 426. PID controller 414 may adjust Tₑₘₒₜ based on an e-motor speed target when HPCM 426 is operating in the speed control mode. PID controller 414 outputs a PID torque term T_{pid}, which is an input into e-motor torque calculation block 410, as described above.

Thus, when engine 420 is decoupled from e-motor 418, an engine torque and a torque converter loss determined at PCM 424 are sent to HPCM 426, where an e-motor torque is calculated. The e-motor torque is held within upper and lower bounds based on a predetermined threshold. The e-motor torque is sent to e-motor 418 to provide tractive force to propel the vehicle. Because the converter loss term T_{conv} is subtracted from the feedforward engine torque value T_{ff} at e-motor torque calculation block 410, the torque converter loss may not be accounted for twice, and an increase in e-motor speed may not occur. Additionally, the e-motor torque Tₑₘₒₜ outputted by e-motor torque calculation block 410 is maintained within upper and lower bounds based on a threshold value, further ensuring that the motor torque Tₑₘₒₜ adheres to operational standards. In this way, a performance of the MHT is increased when decoupling the engine and using the e-motor to propel the vehicle.

FIG. 4B shows a second exemplary control system 450 of the MHT of FIG. 4A, including PCM 424 and HPCM 426. Control system 450 also controls the speed of e-motor 418 in the speed-control mode as engine 420 is decoupled from e-motor 418. Control system 450 takes torque request 404 as input, and outputs an e-motor torque to e-motor 418 to control the speed of the e-motor based on torque request 404. Control system 450 depicts a flow of signals generated when the speed of e-motor 418 is controlled via methods 300 and 350 described above.

In control system 450, torque request 404 is an input into engine torque measurement block 402, where the engine torque T_{eng} is measured (e.g., via a torque sensor such as torque sensor 107). The engine torque T_{eng} outputted by engine torque measurement block 402 is an input into engine 420 when engine 420 is used to propel wheels of the vehicle. The engine torque T_{eng} outputted by engine torque measurement block 402 is also an input into torque converter loss calculation block 406, where the loss in torque due to fluid mechanics inside the torque converter is calculated. The converter loss T_{conv} may be calculated as a function of T_{eng}. In various embodiments, the converter loss T_{conv} may be retrieved from a lookup table stored in memory 430 based on T_{eng}.

In contrast with control system 400 of FIG. 4A, in control system 450 the converter loss T_{conv} is an input into a feedforward (FF) engine torque calculation block 458, where a FF engine torque value T_{ff} is calculated based on T_{eng} and T_{conv}. Specifically, T_{conv} may be subtracted from T_{eng} to obtain T_{ff}, in accordance with equation 5 described in method 300.

The T_{ff} value outputted by FF engine torque calculation block 458 is an input into an upper torque bound calculation block 460 and a lower torque bound calculation block 462. Each of upper torque bound calculation block 460 and lower torque bound calculation block 462 may also receive as an input a torque threshold Tₜₕᵣₑₛₕ outputted by torque threshold calculation block 416. In various embodiments, Tₜₕᵣₑₛₕ is stored in memory 432 of HPCM 426.

At upper torque bound calculation block 460, an upper torque bound Tᵤₚₚₑᵣ of an e-motor torque based on T_{ff} is calculated based on Tₜₕᵣₑₛₕ, in accordance with equation 2 above. At lower torque bound calculation block 462, a lower torque bound T_{lower} of the e-motor torque based on T_{ff} is also calculated based on Tₜₕᵣₑₛₕ, in accordance with equation 3 above.

As described above in reference to methods 300 and 350, the T_{ff} value outputted by FF engine torque calculation block 458, the upper torque bound Tᵤₚₚₑᵣ outputted by the upper torque bound calculation block 460, and the lower torque bound T_{lower} outputted by the lower torque bound calculation block 462 are sent from PCM 424 to HPCM 426 to be inputs into an e-motor torque calculation block 464 of HPCM 426. At e-motor torque calculation block 464, an e-motor torque Tₑₘₒₜ is calculated based on T_{ff}, Tᵤₚₚₑᵣ, T_{lower}, and a PID controller feedback torque term T_{pid}, in accordance with equation 6 above described in reference to method 350. As described above in reference to FIG. 4A, Tₑₘₒₜ is constrained by equation 6 to be within the torque threshold Tₜₕᵣₑₛₕ of T_{ff}. If Tₑₘₒₜ exceeds Tᵤₚₚₑᵣ, e-motor torque calculation block 464 outputs an e-motor torque Tₑₘₒₜ equivalent to −T_{ff}+Tₜₕᵣₑₛₕ. If Tₑₘₒₜ falls below T_{lower}, e-motor torque calculation block 464 outputs an e-motor torque Tₑₘₒₜ equivalent to −T_{ff}−Tₜₕᵣₑₛₕ.

The Tₑₘₒₜ value outputted by e-motor torque calculation block 464 is an input into e-motor 418 to propel the vehicle. The Tₑₘₒₜ value outputted by e-motor torque calculation block 464 is also an input into PID controller 414 of HPCM 426. PID controller 414 may adjust Tₑₘₒₜ based on an e-motor speed target when HPCM 426 is operating in the speed control mode. PID controller 414 outputs a PID torque term T_{pid}, which is an input into e-motor torque calculation block 464, as described above.

Thus, in contrast with control system 400, rather than sending T_{conv} from PCM 424 to HPCM 426 and accounting for the converter loss at the HPCM, the feedforward engine torque value T_{ff} that is sent to HPCM 426 includes a compensation for the converter loss calculated at PCM 424. The upper and lower bounds Tᵤₚₚₑᵣ and T_{lower} are also calculated at PCM 424. As a result, HPCM 426 simply operates PID controller 414 based on the torque values sent from PCM 424. By moving the accounting for converter losses in T_{ff} and calculations of Tᵤₚₚₑᵣ and T_{lower} to PCM 424, an efficiency of transitioning to torque generation via e-motor 418 may be increased. As in control system 400, when engine 420 is decoupled from e-motor 418, the torque converter loss may not be accounted for twice, and the increase in e-motor speed may not occur. FIG. 5 shows an example timing diagram 500, showing an exemplary sequence of events during a disconnection of an engine from an MHT of a hybrid vehicle, when an e-motor of the MHT is operated in a speed control mode to match the torque of the engine and subsequently supply torque to wheels of the vehicle. The MHT may include a powertrain such as powertrain 102 of FIG. 1, where the engine and e-motor may be non-limiting embodiments of engine 104 and e-motor 106. As described above in reference to FIGS. 2A-4B, to avoid a double compensation for power losses at a torque converter of the MHT, a torque of the e-motor may be adjusted based on a torque converter loss term and maintained within allowed thresholds. E-motor torque bounds based on the allowed thresholds may be calculated at a PCM (e.g., PCM 124) of the MHT and sent to an HPCM (e.g., HPCM 126) of the MHT along with a FF engine torque value for the e-motor to match (e.g., via a PID controller), as described in reference to FIGS. 3A and 3B, or the torque bounds may be calculated at the HPCM, as described in reference to FIGS. 2A and 2B. The methods of FIGS. 2A and 2B and the methods of FIGS. 3A and 3B may both result in similar sequences of events as described below.

A horizontal (x-axis) of timing diagram 500 denotes time and the vertical markers t1 and t2 identify significant times in the sequence of events. Timing diagram 500 includes five plots. A first plot, line 502, shows a source of torque generated by the MHT, e.g., how much torque is generated at the engine and how much torque is generated at the e-motor. A second plot, line 504, shows an engine torque T_{eng}, as measured by a torque sensor (e.g., torque sensor 107 of FIG. 1). A third plot, line 506, shows a torque converter loss T_{conv}, which may be a function of T_{eng}. A fourth plot, line 508, shows a torque T_{emot_raw} generated by the e-motor, where T_{emot_raw} overcompensates for the torque converter loss as described above. A dotted line 507 indicates an upper torque bound and a dotted line 509 indicates a lower torque bound, within which T_{emot_raw} must be maintained in accordance with operational standards. A fifth plot, line 510, shows an e-motor torque Tₑₘₒₜ that corrects the overcompensation of T_{emot_raw}, as described above in reference to FIGS. 2A-3B.

Prior to time t1, the vehicle is propelled by torque generated at the engine. T_{eng} is decreasing to zero. For example, the vehicle may be approaching a target velocity where a driver demand for torque decreases.

At time t1, a controller of the MHT initiates a decoupling of the engine from the e-motor, and the HPCM commands the e-motor to begin to generate torque to propel the vehicle (e.g., to maintain the vehicle at the target velocity). The torque T_{emot_raw} generated by the e-motor may be controlled in the speed control mode by a PID controller (e.g., PID controller 127). To match T_{eng}, a FF engine torque value T_{ff} is sent from the PCM controlling the engine to the HPCM, to be an input into the PID controller.

In accordance with the methods of FIGS. 2A and 2B, a torque converter loss term T_{conv} may also be sent, where the HPCM calculates T_{emot_raw} based on T_{ff} and T_{conv}. Upper and lower bounds of T_{emot_raw} indicated by dotted lines 507 and 509 are also generated by the HPCM. Alternatively, in accordance with the methods of FIGS. 3A and 3B, T_{ff} may be calculated to include the torque converter loss at the PCM, and upper and lower bounds Tᵤₚₚₑᵣ and T_{lower} indicated by dotted lines 507 and 509 may be generated by the PCM based on T_{eng}. T_{ff}, Tᵤₚₚₑᵣ and T_{lower} may then be sent from PCM to the HPCM, which calculates Tₑₘₒₜ based on T_{ff}, Tᵤₚₚₑᵣ and T_{lower} (as well as feedback torque component T_{pid} from the PID).

Between time t1 and time t2, the engine continues to be decoupled from the e-motor. T_{emot_raw} continues to be generated based on T_{ff}, Tᵤₚₚₑᵣ and T_{lower}, and T_{pid}. At t2, line 508 shows T_{emot_raw} prior to an adjustment based on T_{conv} and the bounds Tᵤₚₚₑᵣ and T_{lower}, where T_{emot_raw} exceeds T_{lower}, where line 508 crosses line 509. Alternatively, line 510 shows a Tₑₘₒₜ that has been corrected to not overcompensate for the torque converter loss, where T_{emot_raw} is clipped to remain within the bounds Tᵤₚₚₑᵣ and T_{lower} (e.g., where line 510 is constrained by line 509).

Thus, a spike in e-motor speed resulting from accounting for torque converter loss twice may be averted by subtracting converter loss from the engine torque T_{eng} to generate a desired e-motor torque Tₑₘₒₜ, and maintaining Tₑₘₒₜ within the calculated torque bounds. In methods 200 and 250, a converter loss term T_{conv} is sent to the HPCM to be accounted for at the HPCM, and the torque bounds Tᵤₚₚₑᵣ and T_{lower} are calculated at the HPCM. In contrast, in methods 300 and 350, converter loss is accounted for at the PCM prior to sending the feedforward engine torque value T_{ff} to the HPCM, and the torque bounds Tᵤₚₚₑᵣ and T_{lower} are calculated at the PCM. By moving the converter loss subtraction and calculation of Tᵤₚₚₑᵣ and T_{lower} from the HPCM to the PCM, operation of the PID controller of the HPCM (e.g., PID controller 127) may be simplified. In various embodiments, a copy of the torque bounds Tᵤₚₚₑᵣ and T_{lower} may additionally be stored in a memory of the HPCM in case the PCM does not perform properly. If the PCM does not perform properly, the HPCM may not constrain the e-motor torque to within ideal torque bounds, but a deviation of the e-motor torque from a desired value may be based on the value of T_{conv} in the received FF signal and therefore minimized. By ensuring that the torque converter loss is not accounted for twice, a performance of an MHT may be increased.

The technical effect of subtracting a torque converter loss from a feedforward engine torque value used to control a speed of an e-motor of an MHT when an engine of the MHT is decoupled from the e-motor, and maintaining a calculated e-motor torque within torque bounds based on the feedforward engine torque value, is that the torque converter loss may not be accounted for twice, resulting in an increase in a performance of the MHT.

The disclosure also provides support for a method for operating a modular hybrid transmission (MHT) of a of a hybrid vehicle, the method comprising: at one or more control modules, determining upper and lower torque bounds of a feedback controller based on a feedforward (FF) engine torque value, the feedback controller controlling a torque of an electric motor of the hybrid vehicle, and constraining operation of the electric motor via the feedback controller based on the upper and lower torque bounds. In a first example of the method, the feedback controller is a proportional integral derivative (PID) controller. In a second example of the method, optionally including the first example, the one or more control modules include a powertrain control module (PCM) of the hybrid vehicle and a hybrid powertrain control module (HPCM) of the hybrid vehicle. In a third example of the method, optionally including one or both of the first and second examples, the upper and lower torque bounds are calculated by the HPCM. In a fourth example of the method, optionally including one or more or each of the first through third examples, an integral term of the feedback controller is not relied on to account for converter losses during calculation of the upper and lower torque bounds. In a fifth example of the method, optionally including one or more or each of the first through fourth examples, the upper and lower torque bounds are calculated based on the FF engine torque value and a converter loss term, the FF engine torque value and the converter loss term received from the PCM. In a sixth example of the method, optionally including one or more or each of the first through fifth examples, calculating the upper and lower torque bounds based on the FF engine torque value and the converter loss term further comprises adding a threshold torque to the FF engine torque value to obtain the upper torque bound and subtracting the threshold torque from the FF engine torque value to obtain the lower torque bound, the threshold torque stored in a memory of the one or more control modules. In a seventh example of the method, optionally including one or more or each of the first through sixth examples, the upper and lower torque bounds are calculated by the PCM, and sent to the HPCM along with the FF engine torque value. In an eighth example of the method, optionally including one or more or each of the first through seventh examples, the FF engine torque value is determined based on a torque of the engine and known converter losses. In a ninth example of the method, optionally including one or more or each of the first through eighth examples, the known converter losses are retrieved from a lookup table in a memory of the PCM based on the FF engine torque value. In a tenth example of the method, optionally including one or more or each of the first through ninth examples, the upper and lower torque bounds received from the PCM are offsets of the FF engine torque value.

The disclosure also provides support for a powertrain of a hybrid vehicle, comprising: an engine, an electric motor, a torque converter, and an automatic transmission configured as a modular hybrid transmission (MHT), a powertrain control module (PCM), a hybrid powertrain control module (HPCM) storing instructions in non-transitory memory that, when executed, cause the HPCM to control the electric motor based on upper and lower torque bounds, the upper and lower torque bounds based on a feedforward (FF) torque value of the engine. In a first example of the system, the FF torque value is received from the PCM. In a second example of the system, optionally including the first example, further instructions are stored in the non-transitory memory that when executed cause the HPCM to calculate the upper and lower torque bounds based on the FF torque value and a torque converter loss value received from the PCM. In a third example of the system, optionally including one or both of the first and second examples, the upper and lower torque bounds are received from the PCM along with the FF torque value, the upper and lower torque bounds calculated based on the FF torque value and known torque converter losses. In a fourth example of the system, optionally including one or more or each of the first through third examples, the known converter losses are retrieved from a lookup table in a memory of the PCM based on the FF torque value. In a fifth example of the system, optionally including one or more or each of the first through fourth examples, the upper and lower torque bounds received from the PCM are offsets of the FF torque value.

The disclosure also provides support for a method for operating a modular hybrid transmission (MHT) of a of a hybrid vehicle, the method comprising: calculating a feedforward (FF) torque value of an engine of the MHT, calculating an upper bound and a lower bound of a desired torque of an electric motor of the MHT based on the FF torque value, and controlling a torque of the electric motor based on the FF torque value and the upper and lower torque bounds. In a first example of the method, the method further comprises: calculating the FF torque value and the upper and lower torque bounds at a powertrain control module of the MHT, where the FF torque value is based on a torque generated by the engine and known torque converter losses, and controlling the torque of the electric motor at a hybrid powertrain control module of the MHT. In a second example of the method, optionally including the first example, the method further comprises: calculating the FF torque value and a torque converter loss at a powertrain control module of the MHT, and at a hybrid powertrain control module of the MHT, calculating the upper and lower torque bounds based on the FF torque value and a torque converter loss, and controlling the torque of the electric motor.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for operating a modular hybrid transmission (MHT) of a hybrid vehicle, the method comprising:
at one or more control modules, determining an upper torque bound and a lower torque bound of a feedback controller based on a feedforward (FF) engine torque value, the feedback controller controlling a torque of an electric motor of the hybrid vehicle; and
constraining operation of the electric motor via the feedback controller based on the upper and lower torque bounds.

2. The method of claim 1, wherein the feedback controller is a proportional integral derivative (PID) controller.

3. The method of claim 1, wherein the one or more control modules include a powertrain control module (PCM) of the hybrid vehicle and a hybrid powertrain control module (HPCM) of the hybrid vehicle.

4. The method of claim 3, wherein the upper and lower torque bounds are calculated by the HPCM.

5. The method of claim 4, wherein an integral term of the feedback controller is not relied on to account for converter losses during calculation of the upper and lower torque bounds.

6. The method of claim 5, wherein the upper and lower torque bounds are calculated based on the FF engine torque value and a converter loss term, the FF engine torque value and the converter loss term received from the PCM.

7. The method of claim 6, wherein calculating the upper and lower torque bounds based on the FF engine torque value and the converter loss term further comprises adding a threshold torque to the FF engine torque value to obtain the upper torque bound and subtracting the threshold torque from the FF engine torque value to obtain the lower torque bound, the threshold torque stored in a memory of the one or more control modules.

8. The method of claim 3, wherein the upper and lower torque bounds are calculated by the PCM, and sent to the HPCM along with the FF engine torque value.

9. The method of claim 8, wherein the FF engine torque value is determined based on a torque of the engine and known converter losses.

10. The method of claim 9, wherein the known converter losses are retrieved from a lookup table in a memory of the PCM based on the FF engine torque value.

11. The method of claim 8, wherein the upper and lower torque bounds received from the PCM are offsets of the FF engine torque value.

12. A powertrain of a hybrid vehicle, comprising:
an engine, an electric motor, a torque converter, and an automatic transmission configured as a modular hybrid transmission (MHT);
a powertrain control module (PCM);
a hybrid powertrain control module (HPCM) storing instructions in non-transitory memory that, when executed, cause the HPCM to control the electric motor based on upper and lower torque bounds, the upper and lower torque bounds calculated based on a feedforward (FF) torque value of the engine.

13. The powertrain of claim 12, wherein the FF torque value is received by the HPCM from the PCM.

14. The powertrain of claim 13, wherein further instructions are stored in the non-transitory memory that when executed cause the HPCM to calculate the upper and lower torque bounds based on the FF torque value and a torque converter loss value received from the PCM.

15. The powertrain of claim 13, wherein the upper and lower torque bounds are received by the HPCM from the PCM along with the FF torque value, the upper and lower torque bounds calculated based on the FF torque value and known torque converter losses.

16. The powertrain of claim 15, wherein the known converter losses are retrieved from a lookup table in a memory of the PCM based on the FF torque value.

17. The powertrain of claim 16, wherein the upper and lower torque bounds received from the PCM are offsets of the FF torque value.

18. A method for operating a modular hybrid transmission (MHT) of a hybrid vehicle, the method comprising:
calculating a feedforward (FF) torque value of an engine of the MHT;
calculating an upper bound and a lower bound of a desired torque of an electric motor of the MHT based on the FF torque value; and
controlling a torque of the electric motor based on the FF torque value and the upper bound and the lower bound of the desired torque.

19. The method of claim 18, further comprising:
calculating the FF torque value and the upper and lower torque bounds at a powertrain control module of the MHT, where the FF torque value is based on a torque generated by the engine and known torque converter losses; and
controlling the torque of the electric motor at a hybrid powertrain control module of the MHT.

20. The method of claim 18, further comprising:
calculating the FF torque value and a torque converter loss at a powertrain control module of the MHT; and
at a hybrid powertrain control module of the MHT, calculating the upper and lower torque bounds based on the FF torque value and a torque converter loss, and controlling the torque of the electric motor.
